(19) United States
(12) Patent Application Publication
(10) Pub. No.: US 2020/0283699 A1
(43) Pub. Date: Sep. 10, 2020

(54) LAUNDRY PRODUCTS

(71) Applicant: Conopco, Inc., d/b/a UNILEVER, Englewood Cliffs, NJ (US)

(72) Inventors: Deborah Jane COOKE, Chester (GB); David MOORFIELD, Buckley (GB)

(73) Assignee: Conopco, Inc., d/b/a UNILEVER, Englewood Cliffs, NJ (US)

(21) Appl. No.: 16/650,275

(22) PCT Filed: Sep. 20, 2018
(86) PCT No.: PCT/EP2018/075439

§ 371 Date: Mar. 24, 2020

(30) Foreign Application Priority Data
Sep. 29, 2017 (EP) 17194249.3

(51) Int. Cl. C11D 3/00; C11D 3/22; C11D 3/20; C11D 3/386; C11D 3/50; C11D 3/395; C11D 11/00; C11D 17/04; D06F 33/37; D06F 39/02

(52) U.S. Cl. CPC C11D 3/0068; C11D 3/222; C11D 3/2086; C11D 3/2093; C11D 3/0036; C11D 3/386; D06F 2101/02; C11D 3/3956; C11D 11/0017; C11D 17/041; C11D 3/2024; D06F 33/37; D06F 39/022; C11D 3/50

(57) ABSTRACT

A combination of reservoirs providing segregated stocks of components for laundry products to enable a user to formulate doses of laundry products on demand for supplying to a washing machine drum, the combination comprising: a first reservoir containing a stock of a first composition containing a detergent; and a second reservoir containing a second composition comprising a stock of an antimalodour component.

The present invention relates to compositions, systems and methods which provide laundry products tailored to a user's requirement.

In particular, the invention provides compositions, systems and methods which allow a user to customise detergent compositions on demand in order to suit their requirements in their own home.

For many consumers, no single laundry product fulfils all of their needs. As a result, many consumers buy and store more than one laundry product, including biological and non-biological detergent products and those specifically formulated for whites or colours. In addition to storing such laundry products, consumers often store one or more additional stain removal products and/or benefit agents. In total, the combinations can require a significant amount of storage space.

Other consumers may simply use a single laundry product for all loads, regardless of suitability. This can mean that unnecessary components are delivered in the wash (such as enzymes) which may have detrimental effects on fabric case and/or the environment or other components such as particular perfumes which may not be desired by all consumers.

The present invention seeks to address one or more of the problems identified in the prior art.

### SUMMARY

In a first aspect the invention provides a combination of reservoirs providing segregated stocks of components for laundry products to enable a user to formulate doses of laundry products on demand for supplying to a washing machine drum, the combination comprising:
a first reservoir containing a stock of a first composition containing a detergent; and
a second reservoir containing a second composition comprising a stock of an anti-malodour component.

The present stock of components is suitable for use with an apparatus for providing laundry product, the apparatus comprising a dosing unit and a dispensing device, wherein the device is operable to dispense portions of components from the stocks, so as to provide a dose of laundry product in the dosing unit, ready for a wash/rinse process, as a result of command by a user.

A reservoir may contain a stock of a composition in an amount sufficient for two or more doses, preferably for three or more and more preferably for five or more doses of laundry product. In embodiments of the invention a reservoir contains a stock of a composition in an amount sufficient for at least ten doses, optionally at least fifteen doses, preferably at least twenty doses.

A multiple-dose stock of detergent composition according to the invention may also be accommodated in a washing machine which has a dispensing device operable to selectively dispense portions of components from reservoirs as a result of a command by a user to provide a dose of laundry product ready for a wash/rinse cycle.

The combination of the invention may a system including a device operable to selectively dispense components from the reservoirs as a result of command/s by the user thereby formulating the doses of laundry products on demand.

Preferably the anti-malodour component of the second reservoir excludes bleach.

Preferably the anti-malodour component of the second reservoir excludes perfume.

Preferably the anti-malodour component of the second reservoir excludes detergent.

The present invention thus permits the user to combine effective, dedicated anti-malodour component individually with other laundry treatment components, ready for a wash or rinse process. This decouples the anti-malodour benefit from other components such as perfume or bleach or detergent or perfume allowing the user full control over the amount of each.

This also decouple the anti-malodour delivery technology from that of other technologies as the anti-malodour can, be dosed separately. This may be achieved e.g by automatic sequential dosing when the dispensing device is connected and preferably integral to a washing machine or by manually dosing separately which may be aided by dual chambered shuttles or the like.

Accordingly, the combination may further comprise a further reservoir comprising a composition comprising a stock of perfume.

The present invention also provides additional flexibility for the user as it permits the combination of anti-malodour components with other laundry product components at various ratios, in accordance with recipes/directions/guidance. This makes available potentially multiple permutations of laundry product compositions from the stock compositions. For example, higher/lower levels of anti-malodour component may be selected in dependence upon the user's requirements for a particular wash load in terms of the nature and level of soiling and the type of fabric(s) to be washed. So gym/sports garments may be washed with anti-malodour and a higher dose of detergent but a lower dose of perfume. Bedding may be washed with higher doses of each. The present invention thus allows a domestic user to formulate bespoke laundry products in a dosing unit, ready for supply to a washing machine drum.

Embodiments of the present invention may also include directions for combining portions of stock components in order to provide a dose of laundry product.

Methods and devices for combining the contents of the reservoirs are described in more detail below.

A fourth or any further number of reservoirs may be provided containing one or more laundry product components.

### Detergent Composition of the First Reservoir

The detergent composition of the first reservoir may contain detergent actives such as anionic and/or nonionic detergents.

### Surfactants

A detergent base composition may contain a surfactant system which comprises one or more non-soap surfactant components. Preferred surfactant systems comprise at least anionic or nonionic surfactant. Preferably a detergent base is a concentrated composition which contains high levels of a surfactant system. Preferred embodiments contain at least 40 wt %, preferably at least 45 wt % and most preferably at least 50 wt % of a non-soap surfactant system. Suitably the detergent base composition contains up to 80 wt % non-soap surfactant, preferably up to 70 wt %. Soaps may also be included in the compositions, as described later.

### Anionic Surfactants

Preferred anionic surfactants have an anion selected from linear alkyl benzene sulfonate (LAS), primary alkyl sulfate (PAS), alkyl ether sulfate (AES) and mixtures thereof.

Preferred alkyl sulphonates are alkylbenzene sulphonates, particularly linear alkylbenzene sulphonates (LAS) having an alkyl chain length of C₈-C₁₅. The counter ion for anionic surfactants is generally an alkali metal (such sodium) or an ammoniacal counterion (such as MEA, TEA). Suitable anionic surfactant materials are available in the marketplace as the ‘Genapol’™ range from Clariant. Preferred linear alkyl benzene sulphonate surfactants are Detal LAS with an alkyl chain length of from 8 to 15, more preferably 12 to 14. LAS is normally formulated into compositions in acid, i.e., HLAS form and then at least partially neutralized in-situ. Other common anionic surfactants are generally provided in pre-neutralised form.

The compositions may also contain base to provide a counterion for any anionic surfactant, together with performing pH adjustment. Typically a base provides a counterion selected from Na+, K+ and ammoniacal ions. Suitable bases include potassium hydroxide, sodium hydroxide, monoethanolamine, diethanolamine and triethanolammine. Most preferred bases include potassium hydroxide and monoethanolamine. Mixtures of bases may be employed. The composition may optionally contain from 0.1 wt % to 20 wt %, preferably from 0.2 wt % to 15 wt %, more preferably 1 to 10 wt % of base.

A detergent base composition may optionally include an alkyl polyethoxylate sulphate anionic surfactant of the formula (I):

RO(C₂H₄O)ₓSO₃⁻M⁺ (I)

where R is an alkyl chain having from 10 to 22 carbon atoms, especially 12 to 16 carbon atoms and is saturated or unsaturated, M is a cation which makes the compound water-soluble, especially an alkali metal, ammonium or substituted ammonium cation, and x averages from 1 to 15, especially 1 to 3. An example is the anionic surfactant sodium lauryl ether sulphate (SLES) which is the sodium salt of lauryl ether sulphonic acid in which the predominantly C12 lauryl alkyl group has been ethoxylated with an average of 3 moles of ethylene oxide per mole.

Typically a non-soap surfactant system will contain less than 20 wt % of alkyl polyethoxylate sulfate anionic surfactant.

Some alkyl sulphate surfactant (PAS) may be used, especially the non-ethoxylated C₁₂₋₁₅ primary and secondary alkyl sulphates. An example material, commercially available from Cognis, is Sulphopon 1214G.

When included therein the composition may contain from 0.1 wt % to 50 wt %, preferably 0.2 wt % to 50 wt %, more preferably 1 wt % to 45 wt %, and especially 5 to 40 wt % of a anionic surfactant.

### Nonionic Surfactants

Nonionic surfactants include primary and secondary alcohol ethoxylates, especially C₈-C₂₀ aliphatic alcohol ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkyl polyglycosides, glycerol monoethers and polyhydroxy amides (glucamide). Mixtures of nonionic surfactant may be used.

When included therein the composition may contain from 0.1 wt % to 50 wt %, preferably 0.2 wt % to 50 wt %, more preferably 1 wt % to 45 wt %, and especially 5 to 40 wt % of a nonionic surfactant, such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

Nonionic surfactants that may preferably be used include the primary and secondary alcohol ethoxylates, especially the C₈-C₂₀ aliphatic alcohols ethoxylated with an average of from 1 to 35 moles of ethylene oxide per mole of alcohol, and more especially the C₁₀-C₁₅ primary and secondary aliphatic alcohols ethoxylated with an average of from 1 to 10 moles of ethylene oxide per mole of alcohol.

Preferred surfactant systems comprise nonionic and anionic surfactant in a ratio in the range of 20:80 to 80:20, preferably in the range of 40:60 to 80:20 and more preferably in a range of 40:60 to 70:30.

A particularly preferred surfactant system is provided by anionic surfactant comprising linear alkyl benzene sulfonate (LAS) and nonionic surfactant comprising C₁₀-C₁₅ alcohol ethoxylate with 2 to 7 EO.

Amine Oxide Surfactants

The surfactant system of the composition may contain an amine oxide of the formula (2):

R¹N(O)(CH₂R²)₂ (2)

In which R¹ is a long chain moiety and each CH₂R² is a short chain moiety. R² is preferably selected from hydrogen, methyl and —CH₂OH. In general R¹ is a primary or branched hydrocarbyl moiety which can be saturated or unsaturated, preferably, R¹ is a primary alkyl moiety having chain length of from about 8 to about 18 and R² is H. These amine oxides are illustrated by C₁₂₋₁₄ alkyldimethyl amine oxide, hexadecyl dimethylamine oxide, octadecylamine oxide.

Example amine oxide materials are Lauryl dimethylamine oxide, also known as dodecyldimethylamine oxide or DDAO, commercially available from Hunstman under the trade name Empigen® OB.

Amine oxides suitable for use herein are also available from Akzo Chemie and Ethyl Corp. See McCutcheon's compilation and Kirk-Othmer review article for alternate amine oxide manufacturers.

Preferably the detergent compositions contain less than 10 wt %, more preferably less than 5 wt % and especially less than 2 wt % amine oxide surfactant.

### Zwitterionic Surfactants

Some zwitterionic surfactant, such as sulphobetaine, may be present. A preferred zwitterionic material is a betaine available from Huntsman under the name Empigen® BB.

Preferably the detergent compositions contain less than 10 wt %, more preferably less than 5 wt % and especially less than 2 wt % zwitterionic surfactant.

### Cationic Surfactants

Cationic surfactants are preferably substantially absent from the third composition which provides a detergent base composition.

### A Polymer System

A detergent base composition may preferably contain a polymer system which comprises at least one of the following (bi) to (biii):
(bi) one or more particulate soil removal polymer(s) and/or
(bii) one or more anti-redeposition polymer(s) and/or
(biii) one or more soil release polymer(s).

The inclusion of such a polymer system results in enhanced weight efficiency for the compositions. In particular it has been found that such a polymer system contributes to the good dissolution characteristics of the compositions and allows for a reduction in the amount of other non-functional components and solvents required in order to achieve acceptable dissolution.

Example compositions may preferably contain up to 25 wt %, more preferably up to 20 wt % and especially up to 18 wt % of the polymer system. Preferably the compositions contain at least 5 wt %, preferably at least 6 wt % and more preferably at least 7 wt % of the polymer system.

Embodiments may employ an ethoxylated polyethylene imine polymer (EPEI) which may assist with particulate soil removal and/or perform an anti-redeposition function. Preferably the EPEI is nonionic. That means it does not have any quaternary nitrogens, or nitrogen oxides or any ionic species other than possible pH affected protonation of nitrogens.

Polyethylene imines (PEIs, especially modified PEIs) are materials composed of ethylene imine units —CH₂CH₂NH— and, where branched, the hydrogen on the nitrogen is replaced by another chain of ethylene imine units. These polyethyleneimines can be prepared, for example, by polymerizing ethyleneimine in the presence of a catalyst such as carbon dioxide, sodium bisulphite, sulphuric acid, hydrogen peroxide, hydrochloric acid, acetic acid, and the like. Specific methods for preparing these polyamine backbones are disclosed in U.S. Pat. No. 2,182,306, Ulrich et al., issued Dec. 5, 1939; U.S. Pat. No. 3,033,746, Mayle et al., issued May 8, 1962; U.S. Pat. No. 2,208,095, Esselmann et al., issued Jul. 16, 1940; U.S. Pat. No. 2,806,839, Crowther, issued Sep. 17, 1957; U.S. Pat. No. 2,553,696, Wilson, issued May 21, 1951 and WO2006/086492 (BASF).

Preferably, the EPEI comprises a polyethyleneimine backbone wherein the modification of the polyethyleneimine backbone is intended to leave the polymer without quaternisation. Such nonionic EPEI may be represented as PEI(X)YEO where X represents the molecular weight of the unmodified PEI and Y represents the average moles of ethoxylation per nitrogen atom in the polyethyleneimine backbone. The ethoxylation number Y may range from 9 to 40 ethoxy moieties per modification, preferably it is in the range of 16 to 26, most preferably 18 to 22. Xis selected to be from about 300 to about 10000 weight average molecular weight and is preferably about 600.

A preferred example EPEI is PEI (600) 20EO.

If present, the polymer (bi) and/or (bii), such as ethoxylated polyethyleneimine polymer (EPEI), may typically be included in the composition at a level of between 0.01 and 20 wt %, and preferably at a level of at least 1 wt % and/or less than 18 wt %, more preferably at a level of from 2 wt % and/or up to 15 wt %. Particularly preferred compositions contain 3 wt % to 10 wt % and especially 5 to 10 wt % or 4 to 10 wt % EPEI. A ratio of non-soap surfactant to EPEI may preferably be from 2:1 to 9:1, preferably from 3:1 to 8:1, or even to 3:1 to 7:1.

In other embodiments a polymer (bi) and/or (bii) may be omitted.

### Soil Release Polymer

A polymer system of the composition preferably comprises at least some soil release polymer for oily soil removal, especially from polyester.

Soil release polymers improve the main wash performance of the compositions when used in the low in wash surfactant process of the present invention.

One preferred class of polymer is the fabric-substantive polymers comprising at least one of (i) saccharide or (ii) dicarboxylic acid and polyol monomer units. Typically these have soil release properties and while they can have a primary detergency effect they generally assist in subsequent cleaning. Preferably these should be present at a level of at least 2% wt preferably at least 3 wt % of the composition.

If present, the soil release polymer(s) (biii) will generally comprise up to 12.0 wt %, of the detergent composition, preferably up to 9 or 10 wt %. Preferably they are used in an amount of at least 1 or perhaps 2 wt %. Most preferably they are used in an amount of 1 to 9 wt %, more preferably 2 wt % to 9 wt %, especially 2 wt % to 8 wt %.

Generally the soil release polymers for polyester will comprise polymers of aromatic dicarboxylic acids and alkylene glycols (including polymers containing polyalkylene glycols).

The polymeric soil release agents useful herein especially include those soil release agents having:
(a) one or more nonionic hydrophilic components consisting essentially of:
(i) polyoxyethylene segments with a degree of polymerization of at least 2, or
(ii) oxypropylene or polyoxypropylene segments with a degree of polymerization of from 2 to 10, wherein said hydrophilic segment does not encompass any oxypropylene unit unless it is bonded to adjacent moieties at each end by ether linkages, or
(iii) a mixture of oxyalkylene units comprising oxyethylene and from 1 to about 30 oxypropylene units wherein said mixture contains a sufficient amount of oxyethylene units such that the hydrophilic component has hydrophilicity great enough to increase the hydrophilicity of conventional polyester synthetic fibre surfaces upon deposit of the soil release agent on such surface, said hydrophilic segments preferably comprising at least about 25% oxyethylene units and more preferably, especially for such components having about 20 to 30 oxypropylene units, at least about 50% oxyethylene units; or
(b) one or more hydrophobic components comprising:
(i) C₃ oxyalkylene terephthalate segments, wherein, if said hydrophobic components also comprise oxyethylene terephthalate, the ratio of oxyethylene terephthalate: C₃ oxyalkylene terephthalate units is about 2:1 or lower,
(ii) C₄-C₆ alkylene or oxy C₄-C₆ alkylene segments, or mixtures therein,
(iii) poly (vinyl ester) segments, preferably polyvinyl acetate), having a degree of polymerization of at least 2, or (iv) C₁-C₄ alkyl ether or C₄ hydroxyalkyl ether substituents, or mixtures therein, wherein said substituents are present in the form of C₁-C₄ alkyl ether or C₄ hydroxyalkyl ether cellulose derivatives, or mixtures therein, and such cellulose derivatives are amphiphilic, whereby they have a sufficient level of C₁-C₄ alkyl ether and/or C₄ hydroxyalkyl ether units to deposit upon conventional polyester synthetic fibre surfaces and retain a sufficient level of hydroxyls, once adhered to such conventional synthetic fibre surface, to increase fibre surface hydrophilicity, or a combination of (a) and (b).

Typically, the polyoxyethylene segments of (a)(i) will have a degree of polymerization of from about 200, although higher levels can be used, preferably from 3 to about 150, more preferably from 6 to about 100. Suitable oxy C₄-C₆ alkylene hydrophobic segments include, but are not limited to, end-caps of polymeric soil release agents such as MO₃S(CH₂)ₙOCH₂CH₂O—, where M is sodium and n is an integer from 4-6, as disclosed in U.S. Pat. No. 4,721,580, issued Jan. 26, 1988 to Gosselink.

Soil release agents characterized by poly(vinyl ester) hydrophobic segments include graft copolymers of poly(vinyl ester), e.g., C₁-C₆ vinyl esters, preferably poly(vinyl acetate) grafted onto polyalkylene oxide backbones, such as polyethylene oxide backbones. See European Patent Application 0 219 048, published Apr. 22, 1987 by Kud, et al. Commercially available soil release agents of this kind include the SOKALAN type of material, e.g., SOKALAN HP-22, available from BASF (West Germany).

One type of preferred soil release agent is a copolymer having random blocks of ethylene terephthalate and polyethylene oxide (PEO) terephthalate. The molecular weight of this polymeric soil release agent is in the range of from about 25,000 to about 55,000. See U.S. Pat. No. 3,959,230 to Hays, issued May 25, 1976 and U.S. Pat. No. 3,893,929 to Basadur issued Jul. 8, 1975.

Another preferred polymeric soil release agent is a polyester with repeat units of ethylene terephthalate units contains 10 to 15 wt % of ethylene terephthalate units together with 90 to 80 wt % weight of polyoxyethylene terephthalate units, derived from a polyoxyethylene glycol of average molecular weight 300-5,000. Examples of this polymer include the commercially available material ZELCON 5126 (from DuPont) and MILEASE T (from ICI). See also U.S. Pat. No. 4,702,857, issued Oct. 27, 1987 to Gosselink.

Another preferred polymeric soil release agent is a sulphonated product of a substantially linear ester oligomer comprised of an oligomeric ester backbone of terephthaloyl and oxyalkyleneoxy repeat units and terminal moieties covalently attached to the backbone. These soil release agents are described fully in U.S. Pat. No. 4,968,451, issued Nov. 6, 1990 to J. J. Scheibel and E. P. Gosselink. Other suitable polymeric soil release agents include the terephthalate polyesters of U.S. Pat. No. 4,711,730, issued Dec. 8, 1987 to Gosselink et al, the anionic end-capped oligomeric esters of U.S. Pat. No. 4,721,580, issued Jan. 26, 1988 to Gosselink, and the block polyester oligomeric compounds of U.S. Pat. No. 4,702,857, issued Oct. 27, 1987 to Gosselink.

Preferred polymeric soil release agents also include the soil release agents of U.S. Pat. No. 4,877,896, issued Oct. 31, 1989 to Maldonado et al, which discloses anionic, especially sulfoarolyl, end-capped terephthalate esters.

Still another preferred soil release agent is an oligomer with repeat units of terephthaloyl units, sulfoisoterephthaloyl units, oxyethyleneoxy and oxy-1,2-propylene units. The repeat units form the backbone of the oligomer and are preferably terminated with modified isethionate end-caps. A particularly preferred soil release agent of this type comprises about one sulfoisophthaloyl unit, 5 terephthaloyl units, oxyethyleneoxy and oxy-1,2-propyleneoxy units in a ratio of from about 1.7 to about 1.8, and two end-cap units of sodium 2-(2-hydroxyethoxy)-ethanesulphonate. Said soil release agent also comprises from about 0.5% to about 20%, by weight of the oligomer, of a crystalline-reducing stabilizer, preferably selected from the group consisting of xylene sulfonate, cumene sulfonate, toluene sulfonate, and mixtures thereof.

Suitable soil release polymers are described in WO 2008095626 (Clariant); WO 2006133867 (Clariant); WO 2006133868 (Clariant); WO 2005097959 (Clariant); WO 9858044 (Clariant); WO 2000004120 (Rhodia Chimie); U.S. Pat. No. 6,242,404 (Rhodia Inc); WO 2001023515 (Rhodia Inc); WO 9941346 (Rhodia Chim); WO 9815346 (Rhodia Inc); WO 9741197 (BASF); EP 728795 (BASF); U.S. Pat. No. 5,008,032 (BASF); WO 2002077063 (BASF); EP 483606 (BASF); EP 442101 (BASF); WO 9820092 (Proctor & Gamble); EP 201124 (Proctor & Gamble); EP 199403 (Proctor & Gamble); DE 2527793 (Proctor & Gamble); WO 9919429 (Proctor & Gamble); WO 9859030 (Proctor & Gamble); U.S. Pat. No. 5,834,412 (Proctor & Gamble); WO 9742285 (Proctor & Gamble); WO 9703162 (Proctor & Gamble); WO 9502030 (Proctor & Gamble); WO 9502028 (Proctor & Gamble); EP 357280 (Proctor & Gamble); U.S. Pat. No. 4,116,885 (Proctor & Gamble); WO 9532232 (Henkel); WO 9532232 (Henkel); WO 9616150 (Henkel); WO 9518207 (Henkel); EP 1099748 (Henkel); FR 2619393 (Colgate Palmolive); DE 3411941 (Colgate Palmolive); DE 3410810 (Colgate Palmolive); WO 2002018474 (RWE-DEA MINERALOEL & CHEM AG; SASOL GERMANY GMBH); EP 743358 (Textil Color AG); PL 148326 (Instytut Ciezkiej Syntezy Organicznej “Blachownia”, Pol.); JP 2001181692 (Lion Corp); JP 11193397 A (Lion Corp); RO 114357 (S.C. “Prod Cresus” S.A., Bacau, Rom.); and U.S. Pat. No. 7,119,056 (Sasol).

The most preferred soil release polymers are the water soluble/miscible or dispersible polyesters such as: linear polyesters sold under the Repel-O-Tex brand by Rhodia (Gerol), or the Texcare brand by Clariant, especially Texcare SRN100 and SRN170, and heavily branched polyesters such as those available from Sasol and described in U.S. Pat. No. 7,119,056. The polyesters are preferably nonionic and comprise a mid block of spaced apart terephthalate repeat units and at least one end block based on polyethylene glycol with a lower alkyl or hydrogen termination.

Example soil release polymers may also be of the type E-M-L-E, where the ester midblock M is connected to generally hydrophilic end blocks E, each comprising capped oligomers of polyethylene glycol, the linking moiety L is of the form B—Ar—B, where B is a urethane, amide or ester moiety. Such soil release polymers are described in WO2012/104159.

Particularly preferred polymer systems (bi), (bii) and (biii) are combinations of relatively high levels of EPEI, particularly greater than 2.5 wt % based on the composition, with soil release polymers.

The polymer system (b) may typically be present in an amount such that the ratio of polymer system (b) to surfactant system is in a range of 0.15:1 to 0.4:1, preferably 0.2:1 to 0.4:1 and more preferably 0.2:1 to 0.3:1.

### Water

The detergent base compositions are intended to be highly weight efficient and as such may contain relatively low levels of water, preferably up to 15 wt % added water. Preferred embodiments contain up to 12 wt % and more preferably up to 10 wt % added water. The amount of water will vary in dependence upon the dose volume required.

The compositions may also contain water provided as a component of a raw material. Preferably the total water content of the composition (as provided by the raw materials and as added water) is less than 20 wt %, preferably less than 15 wt % and more preferably less than 12 wt %.

### Fatty Acid/Soap

The detergent base compositions may comprise fatty acid and/or soap, preferably in an amount up to 10 wt %, especially up to 8 wt % and most preferably up to 5 or 6 wt % fatty acid. Typically a composition may contain at least 0.1 wt % fatty acid and preferably at least 1 wt %.

Preferred example fatty acids contain 8 to 24 carbon atoms, preferably in a straight chain configuration, saturated or unsaturated. Particularly preferred fatty acids include those where the weighted average number of carbons in the alkyl/alkenyl chains is from 8 to 24, more preferably 10 to 22, most preferably from 12 to 18. Suitably fatty acids include linear and branched stearic, oleic, lauric, linoleic and tallow acids and mixtures thereof.

Particularly preferred blends of fatty acids that are commercially available include: hydrogenated topped palm kernel fatty acid, and coconut fatty acid saturated fatty acids are preferred. The fatty acid can act as a buffer in addition to preforming a builder and/or as an antifoam. Fatty acids may form part of a buffer system that provides buffering in a pH range of 5 to 9. Preferably the present detergent compositions have a pH in those ranges when measured on dilution of the liquid composition to 1% using demineralised water. The most preferred pH range all vary in dependence upon the polymer system; soil release polymers in particular can have reduced stability under certain conditions of pH.

### Base

As described above in relation to the anionic surfactant, a detergent base composition may preferably contain from 1 to 15 wt %, more preferably from 1 to 10 wt % in total of base which may provide a counterion for any anionic surfactant and perform a pH adjustment function. Suitable bases include potassium hydroxide, sodium hydroxide, monoethanolamine, diethanolamine and triethanolammine. A most preferred base is monoethanolamine. Mixtures of bases may be employed.

### Solvent and Hydrotropes

As the present detergent base compositions are intended to be highly weight efficient it is proposed that a base composition contains less than 40 wt %, preferably less than 35 wt %, more preferably less than 30 wt % and especially less than 20 wt % of any solvents and hydrotropes. Generally the solvents are “non-amino functional”.

In this context, “non-amino functional solvent” refers to any solvent that does not contain amino functional groups. It includes non-surfactant solvents such as C₁-C₅ alcohols (such as ethanol), C₂-C₆ diols (such as monopropylene glycol and dipropylene glycol) and C₃-C₉ triols (such as glycerol). In preferred embodiments the solvents are optionally selected from one or more of glycerol, monopropylene glycol (MPG) and ethanol.

The level of such solvents including non-amino functional solvents will vary in dependence upon the dose volumes required. Amino-functional materials are not included in the category of solvents as they would be classified by the skilled reader as a base.

In the present detergent base compositions the combined total amount of added water and solvents is preferably less than 45 wt % and more preferably less than 40 wt %.

### Anti-Malodour Composition of the Second Reservoir

The anti-malodour composition of the second reservoir may contain any suitable anti-malodour component.

Preferred examples of the anti-malodour compositions may contain anti-malodour components in an amount of 1 to 90 wt %, (of the anti-malodour composition)

Any suitable anti-malodour component may be used or any combination of the agents below. Indeed, an anti-malodour effect may be achieved by any compound or product that is effective to “trap”, “absorb” or “destroy” odour molecules to thereby separate or remove odour from the garment.

The anti-malodour component may be selected from the group consisting of: uncomplexed cyclodextrin; odour blockers; reactive aldehydes; flavanoids; zeolites; activated carbon; and mixtures thereof.

Preferably the uncomplexed cyclodextrin is water soluble. As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in donut-shaped rings.

Preferably, the cyclodextrins are highly water-soluble such as, alpha-cyclodextrin and/or derivatives thereof, gamma-cyclodextrin and/or derivatives thereof, derivatised beta-cyclodextrins, and/or mixtures thereof. The derivatives of cyclodextrin consist mainly of molecules wherein some of the OH groups are converted to OR groups. Cyclodextrin derivatives include, e.g., those with short chain alkyl groups such as methylated cyclodextrins, and ethylated cyclodextrins, wherein R is a methyl or an ethyl group; those with hydroxyalkyl substituted groups, such as hydroxypropyl cyclodextrins and/or hydroxyethyl cyclodextrins, wherein R is a —CH₂—CH(OH)—CH₃ or a —CH₂CH₂—OH group; branched cyclodextrins such as maltose-bonded cyclodextrins; cationic cyclodextrins such as those containing 2-hydroxy-3-(dimethylamino)propyl ether, wherein R is CH₂—CH(OH)—CH₂—N(CH₃)₂ which is cationic at low pH; quaternary ammonium, e.g., 2-hydroxy-3-(trimethylammonio)propyl ether chloride groups, wherein R is CH₂—CH(OH)—CH₂—N+(CH₃)₃Cl⁻; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomalto structure, e.g., the mono-3-6-anhydrocyclodextrins

Highly water-soluble cyclodextrins are those having water solubility of at least about 10 g in 100 ml of water at room temperature, preferably at least about 20 g in 100 ml of water, more preferably at least about 25 g in 100 ml of water at room temperature. The availability of solubilized, uncomplexed cyclodextrins is essential for effective and efficient anti-malodour performance. Solubilized, water-soluble cyclodextrin can exhibit more efficient anti-malodour performance than non-water-soluble cyclodextrin when deposited onto surfaces, especially fabric.

Examples of preferred water-soluble cyclodextrin derivatives suitable for use herein are hydroxypropyl alpha-cyclodextrin, methylated alpha-cyclodextrin, methylated beta-cyclodextrin, hydroxyethyl beta-cyclodextrin, and hydroxypropyl beta-cyclodextrin. Hydroxyalkyl cyclodextrin derivatives preferably have a degree of substitution of from about 1 to about 14, more preferably from about 1.5 to about 7, wherein the total number of OR groups per cyclodextrin is defined as the degree of substitution. Methylated cyclodextrin derivatives typically have a degree of substitution of from about 1 to about 18, preferably from about 3 to about 16. A known methylated beta-cyclodextrin is heptakis-2,6-di-O-methyl-β-cyclodextrin, commonly known as DIMEB, in which each glucose unit has about 2 methyl groups with a degree of substitution of about 14. A preferred, more commercially available, methylated beta-cyclodextrin is a randomly methylated beta-cyclodextrin, commonly known as RAMEB, having different degrees of substitution, normally of about 12.6. RAMEB is more preferred than DIMEB, since DIMEB affects the surface activity of the preferred surfactants more than RAMEB. The preferred cyclodextrins are available, e.g., from Cerestar U.S.A., Inc. and Wacker Chemicals (U.S.A.), Inc.

In embodiments mixtures of cyclodextrins are used.

So called “Odour blockers” can be used as an anti-malodour component to mitigate the effects of malodours. Non-limiting examples of odour blockers include 4-cyclohexyl-4-methyl-2-pentanone, 4-ethylcyclohexyl methyl ketone, 4-isopropylcyclohexyl methyl ketone, cyclohexyl methyl ketone, 3-methylcyclohexyl methyl ketone, 4-tert.-butylcyclohexyl methyl ketone, 2-methyl-4-tert.butylcyclohexyl methyl ketone, 2-methyl-5-isopropylcyclohexyl methyl ketone, 4-methylcyclohexyl isopropyl ketone, 4-methylcyclohexyl secbutyl ketone, 4-methylcyclohexyl isobutyl ketone, 2,4-dimethylcyclohexyl methyl ketone, 2,3-dimethylcyclohexyl methyl ketone, 2,2-dimethylcyclohexyl methyl ketone, 3,3-dimethylcyclohexyl methyl ketone, 4,4-dimethylcyclohexyl methyl ketone, 3,3,5-trimethylcyclohexyl methyl ketone, 2,2,6-trimethylcyclohexyl methyl ketone, 1-cyclohexyl-1-ethyl formate, 1-cyclohexyl-1-ethyl acetate, 1-cyclohexyl-1-ethyl propionate, 1-cyclohexyl-1-ethyl isobutyrate, 1-cyclohexyl-1-ethyl n-butyrate, 1-cyclohexyl-1-propyl acetate, 1-cyclohexyl-1-propyl n-butyrate, 1-cyclohexyl-2-methyl-1-propyl acetate, 2-cyclohexyl-2-propyl acetate, 2-cyclohexyl-2-propyl propionate, 2-cyclohexyl-2-propyl isobutyrate, 2-cyclohexyl-2-propyl nbutyrate, 5,5-dimethyl-1,3-cyclohexanedione (dimedone), 2,2-dimethyl-1,3-dioxane-4,6-dione (Meldrum's acid), spiro-[4.5]-6,10-dioxa-7,9-dioxodecane, spiro-[5.5]-1,5-dioxa-2,4-dioxoundecane, 2,2-hydroxymethyl-1,3-dioxane-4,6-dione and 1,3-cyclohexadione. Odour blockers are disclosed in more detail in U.S. Pat. Nos. 4,009,253; 4,187,251; 4,719,105; 5,441,727; and 5,861,371, incorporated herein by reference.

Reactive aldehydes can be used as anti-malodour component to mitigate the effects of malodours. Examples of suitable reactive aldehydes include Class I aldehydes and Class 11 aldehydes. Examples of Class I aldehydes include anisic aldehyde, o-allyl-vanillin, benzaldehyde, cuminic aldehyde, ethylaubepin, ethyl-vanillin, heliotropin, tolyl aldehyde, and vanillin. Examples of Class II aldehydes include 3-(4′-tert.butylphenyl)propanal, 2-methyl-3-(4′-tertbutylphenyl)propanal, 2-methyl-3-(4′-isopropylphenyl)propanal, 2,2-dimethyl-3-(4-ethylphenyl)propanal, cinnamic aldehyde, a-amyl-cinnamic aldehyde, and a-hexyl-cinnamic aldehyde. These reactive aldehydes are described in more detail in U.S. Pat. No. 5,676,163. Reactive aldehydes, when used, can include a combination of at least two aldehydes, with one aldehyde being selected from acyclic aliphatic aldehydes, non-terpenic aliphatic aldehydes, non-terpenic alicyclic aldehydes, terpenic aldehydes, aliphatic aldehydes substituted by an aromatic group and bifunctional aldehydes; and the second aldehyde being selected from aldehydes possessing an unsaturation alpha to the aldehyde function conjugated with an aromatic ring, and aldehydes in which the aldehyde group is on an aromatic ring. This combination of at least two aldehydes is described in more detail in WO 00/49120. As used herein, the term “reactive aldehydes” further encompasses deodourizing materials that are the reaction products of (i) an aldehyde with an alcohol, (ii) a ketone with an alcohol, or (iii) an aldehyde with the same or different aldehydes. Such deodourizing materials can be: (a) an acetal or hemiacetal produced by means of reacting an aldehyde with a carbinol; (b) a ketal or hemiketal produced by means of reacting a ketone with a carbinol; (c) a cyclic triacetal or a mixed cyclic triacetal of at least two aldehydes, or a mixture of any of these acetals, hemiacetals, ketals, hemiketals, or cyclic triacetals. These deodorizing perfume materials are described in more detail in WO 01/07095 incorporated herein by reference.

Flavanoids can also be used as anti-malodour component. Flavanoids are compounds based on the C6-C3-C6 flavan skeleton. Flavanoids can be found in typical essential oils.

Such oils include essential oil extracted by dry distillation from needle leaf trees and grasses such as cedar, Japanese cypress, eucalyptus, Japanese red pine, dandelion, low striped bamboo and cranesbill and can contain terpenic material such as alpha-pinene, beta-pinene, myrcene, phencone and camphene. Also included are extracts from tea leaf. Descriptions of such materials can be found in JP 02284997 and JP 04030855 incorporated herein by reference.

Metallic salts can also be used as anti-malodour components for malodour control benefits. Examples include metal salts of fatty acids. Ricinoleic acid is a preferred fatty acid. Zinc salt is a preferred metal salt. The zinc salt of ricinoleic acid is especially preferred. A commercially available product is TEGO Sorb A30 ex Evonik. Further details of suitable metallic salts is provided below.

Zeolites can be used as anti-malodour component. A useful class of zeolites is characterized as “intermediate” silicate/aluminate zeolites. The intermediate zeolites are characterized by SiO₂/A102 molar ratios of less than about 10. Preferably the molar ratio of SiO₂/AlO₂ ranges from about 2 to about 10. The intermediate zeolites can have an advantage over the “high” zeolites. The intermediate zeolites have a higher affinity for amine-type odours, they are more weight efficient for odour absorption because they have a larger surface area, and they are more moisture tolerant and retain more of their odour absorbing capacity in water than the high zeolites. A wide variety of intermediate zeolites suitable for use herein are commercially available as Valfor® CP301-68, Valfor® 300-63, Valfor® CP300-35, and Valfor® CP300-56, available from PQ Corporation, and the CBV100® series of zeolites from Conteka. Zeolite materials marketed under the trade name Abscents® and Smellrite®, available from The Union Carbide Corporation and UOP are also preferred. Such materials are preferred over the intermediate zeolites for control of sulfur-containing odours, e.g., thiols, mercaptans. Suitably the zeolite material has a particle size of less than about 10 microns and is present in the composition at a level of less than about 1% by weight of the composition.

Activated carbon is another suitable anti-malodour component. Suitable carbon material is a known absorbent for organic molecules and/or for air purification purposes. Often, such carbon material is referred to as “activated” carbon or “activated” charcoal. Such carbon is available from commercial sources under such trade names as; Calgon-Type CPG®; Type PCB®; Type SGL®; Type CAL®; and Type OL®. Suitably the activated carbon preferably has a particle size of less than about 10 microns and is present in the anti-malodour composition at a level of less than about 1% by weight of the anti-malodour composition.

Exemplar anti-malodour components are as follows.

ODOBAN™ is manufactured and distributed by Clean Central Corp. of Warner Robins, Ga. Its active ingredient is alkyl (C14 50%, C12 40% and C16 10%) dimethyl benzyl ammonium chloride which is an antibacterial quaternary ammonium compound. The alkyl dimethyl benzyl ammonium chloride is in a solution with water and isopropanol. Another product by Clean Control Corp. is BIOODOUR CONTROL™ which includes water, bacterial spores, alkylphenol ethoxylate and propylene glycol.

ZEOCRYSTAL FRESH AIR MIST™ is manufactured and distributed by Zeo Crystal Corp. (a/k/a American Zeolite Corporation) of Crestwood, Ill. The liquid comprises chlorites, oxygen, sodium, carbonates and citrus extract, and may comprise zeolite.

The anti-malodour component may comprise a malodour counteractant as described in US2005/0113282A1 by which is hereby incorporated by reference. In particular this malodour counteractant may comprise a mixture of zinc ricinoleate or a solution thereof and a substituted monocyclic organic compound as described at page 2, paragraph 17 whereby the substituted monocyclic organic compound is in the alternative or in combination one or more of:
1-cyclohexylethan-1-yl butyrate;
1-cyclohexylethan-1-yl acetate;
1-cyclohexylethan-1-ol;
1-(4′-methylethyl) cyclohexylethan-1-yl propionate; and
2′-hydroxy-1′-ethyl(2-phenoxy)acetate.

Synergistic combinations of malodour counteractants as disclosed at paragraphs 38-49 are suitable, for example, the compositions comprising:
(i) from about 10 to about 90 parts by weight of at least one substituted monocyclic organic compound-containing material which is:

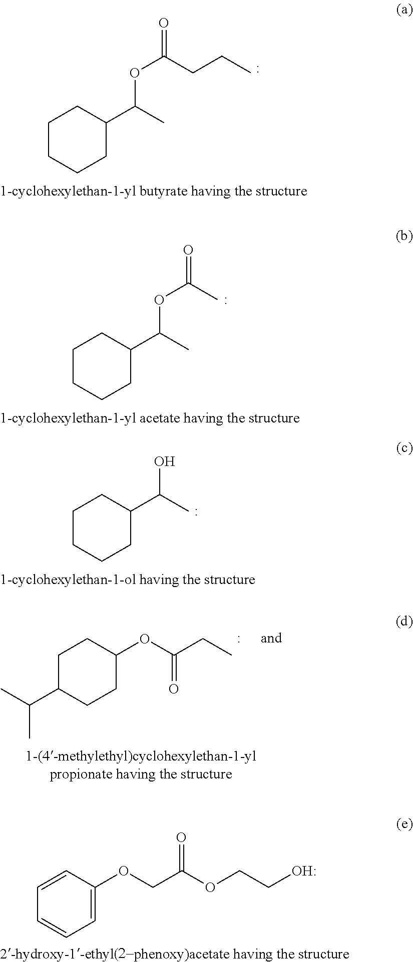

and (ii) from about 90 to about 10 parts by weight of a zinc ricinoleate-containing composition which is zinc ricinoleate and/or solutions of zinc ricinoleate containing greater than about 30% by weight of zinc ricinoleate. Preferably, the aforementioned zinc ricinoleate-containing compositions are mixtures of about 50% by weight of zinc ricinoleate and about 50% by weight of at least one 1-hydroxy-2-ethoxyethyl ether of a More specifically, a preferred composition useful in combination with the zinc ricinoleate component is a mixture of:
(A) 1-cyclohexylethan-1-yl butyrate;
(B) 1-cyclohexylethan-1-yl acetate; and
(C) 1-(4′-methylethyl)cyclohexylethan-1-yl propionate.

More preferably, the weight ratio of components of the immediately-aforementioned zinc riconoleate-containing mixture is one where the zinc ricinoleate-containing composition: 1-cyclohexylethan-1-yl butyrate: 1-cyclohexylethan-1-yl acetate: 1-(4′-methylethyl)-cyclohexylethan-1-yl propionate is about 2:1:1:1.

Another preferred composition useful in combination with the zinc ricinoleate component or solution is a mixture of:
(A) 1-cyclohexylethan-1-yl acetate; and
(B) 1-(4′-methylethyl)cyclohexylethan-1-yl propionate.

More preferably, the weight ratio of components of the immediately-aforementioned zinc riconoleate mixture is one where the zinc ricinoleate-containing composition: 1-cyclohexylethan-1-yl acetate: 1-(4′-methylethyl)cyclohexylethan-1-yl propionate is about 3:1:1.

To the extent any material described herein as an anti-malodour component might also be classified as another component described herein, for purposes of the present invention, such material shall be classified as an anti-malodour component.

Suitably the anti-malodour composition contains solvent and/or plasticizer. Solvents and plasticizers act to aid the natural ability of water to plasticize fibers. Acceptable solvents and plasticizers include compounds having from one to ten carbons. The following non-limiting classes of compounds are suitable: mono-alcohols, dials, polyhydric alcohols, ethers, ketones, esters, organic acids, and alkyl glyceryl ethers, and hydrocarbons. Preferred solvents are soluble in water and/or miscible in the presence of optional surfactant. Examples include methanol, ethanol, isopropanol, hexanol, 1,2-hexanediol, hexylene glycol, (e.g. 2-methyl-2,4-pentanediol), isopropylene glycol (3-methyl-1,3-butanediol), 1,2-butylene glycol, 2,3-butylene glycol, 1,3-butylene glycol, 1,4-butylene glycol, 1,3-propylene glycol, 1,2-propylene glycol, isomers of cyclohexanedimethanol, isomers of propanediol, isomers of butanediol, the isomers of trimethylpentanediol, the isomers of ethylmethylpentanediol, alcohol ethoxylates of 2-ethyl-1,3-hexanediol, 2,2,4-trimethyl-1,3-pentanediol, alcohol ethoxylates of 2,2,4-trimethyl-1,3-pentanediol glycerol, ethylene glycol, diethylene glycol, dipropylene glycol, sorbitol, butoxy ethoxy ethanol, 3-methyl-3-methoxybutanol, 3-methoxybutanol, 1-ethoxy-2-propanol, diethylene glycol monoethyl ether, diethylene glycol monopropyl ether, diethylene glycol monobutyl ether, triethylene glycol monoethyl ether, erythritol, and mixtures of solvents and plasticizers. When solvent is used, it is typically present at a level selected from at least 0.5%, at least 1%, at least 2%, at least 3%, and at least 4% by weight of the anti-malodour composition. Suitably it is present at a level selected from less than 30%, less than 25%, less than 20%, and less than 15% by weight of the anti-malodour composition.

To the extent any material described herein as an anti-malodour component might also be classified as another component described herein, for purposes of the present invention, such material shall be classified as an anti-malodour component.

### Deposition Aids

The anti-malodour composition may comprise deposition aid. As used herein, a “deposition aid” is a material that assists another material (e.g., anti-malodour component/s) to deposit (e.g., adhere) to a targeted substrate. The term “deposition aid” is broad enough to encompass both polymeric deposition aids (i.e. “deposition polymer”) and non-polymeric deposition aids.

Polymeric deposition aid/s are suitably present at a level of from 0.01 to 5% by total weight of the composition preferably from 0.02 to 3%, more preferably from 0.2 to 2% and most preferably from 0.5 to 1.6%. Polymeric deposition agent suitable for use in the present invention include modified natural polymers and synthetic polymers.

Polymers suitable are disclosed in WO9709406, particularly high MW polyethylene oxides (PEO) which are used to deposit clay particles in the main wash; EP0299575B1 and WO9527037 disclose high MW PEO, polyacrylates, polyacryl amides, poly vinyl alcohol and poly ethylene imines, and EP0387426B1 which utilizes a similar list of polymers as well as guar gums.

Preferred synthetic polymers, for use as a deposition aid, may be selected from the group consisting of polyethylene oxide (PEO), polyethylene imine (PEI), poly (acrylate), poly (acrylamide), polyethylene terephthalate-polyoxyethylene terephthalate (PET/POET) polymers and mixtures thereof.

The deposition aid may comprise a polysaccharide. The polysaccharide preferably has a β-1,4-linked backbone. Preferably the polysaccharide is a cellulose, a cellulose derivative, or another β-1,4-linked polysaccharide having an affinity for cellulose, such as polymannan, polyglucan, polyglucomannan, polyxyloglucan and polygalactomannan or a mixture thereof. More preferably, the polysaccharide is selected from the group consisting of polyxyloglucan and polygalactomannan.

Highly preferred polysaccharides are selected from locust bean gum, tamarind gum, xyloglucan, non-ionic guar gum, cationic starch and mixtures thereof. Most preferably, the deposition aid is locust bean gum.

The polysaccharide may be straight or branched. Many naturally occurring polysaccharides have at least some degree of branching, or at any rate at least some saccharide rings are in the form of pendant side groups (which are therefore not in themselves counted in determining the degree of substitution) on a main polysaccharide backbone. Preferably, the polysaccharide is present at levels of between 0.1% to 10% w/w by weight of the total amount of the particle.

Suitable examples of cationic polymers include cationic guar polymers such as Jaguar (ex Rhone Poulenc), cationic cellulose derivatives such as Celquats (ex National Starch), Flocaid (ex National Starch), cationic potato starch such as Softgel (ex Aralose) and cationic polyacrylamides such as PCG (ex Allied Colloids). Suitable non-ionic deposition aids include high molecular weight polyethylene glycols, for example PEO WSRN 750 (ex Union Carbide).

### Further Laundry Reservoirs

Further reservoir compositions may include any one or combination of the following:

### Bleach Reservoir

A bleach reservoir component may be provided comprising a bleach component suitable for use in a laundry process. Preferably the bleach component comprises an oxygen bleach system. Such bleach systems may be, for example, a peroxygen bleach or a peroxy—based or peroxy—generating system.

Mixtures of bleaches can also be used.

Preferably the bleach component is selected so as to be easy to handle and storable according to the requirements for the least hazardous class of organic peroxides. This allows the first composition to be safely transported to and stored in a domestic setting.

A preferred category of bleaches includes percarboxylic acid bleaching agents, salts and precursors thereof, especially organic percarboxylic acids, salts and precursors thereof, particularly aromatic percarboxylic acids and salts thereof and especially heteroaromatic peroxycarboxylic acids and salts thereof. Particularly preferred embodiments employ 6-(phthalimido) peroxyhexanoic acid (PAP) and salts thereof.

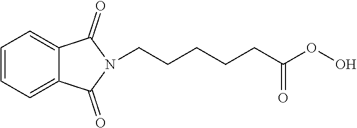 [SMILES: O=C(CCCCCN1C(=O)c2ccccc2C1=O)OO]

Suitable grades of PAP are commercially available under the trade name Eureco.

Example liquid grades include Eureco LX5, LX10 and LX17 which are stabilized aqueous suspensions of PAP crystals.

Further examples of oxygen-based bleach are available under the trade name Suprox. Typically a first composition may comprise up to 20 wt % of bleach component, especially up to 19 wt % and preferably up to 18 wt %. Suitably a first composition may comprise at least 1 wt % especially at least 2 wt %, preferably at least 3 wt %, more preferably at least 4 wt % of bleach component.

Peroxygen bleaches, perborates and percarbonates may also be combined with bleach activators which lead to the in situ production during the washing process of a peroxy acid corresponding to the bleach activator. Examples of preferred peroxy acid bleach precursors or activators are TAED (N, N, N′ N′-tetraacetyl ethylene diamine) and SNOBS (sodium nonanoyloxybenzene sulphonate).

The first composition may be in the form of a liquid, gel or powder, for example. In preferred embodiments the first composition is in the form of a liquid, which may comprise a suspension of bleach component. If the first composition and/or bleach component are in liquid form a bleach activator may preferably be provided in a different reservoir to the bleach component.

### First Composition—Solvents/Carriers

Various solvents and carriers typically employed in laundry detergent formulations may be included in the bleach composition, provided that they are compatible with the bleach component.

The bleach component may optionally comprise water and/or non-aqueous carrier solvents in an amount of up to 85 wt %, preferably up to 80 wt %, more preferably up to 75 wt % or up to 70 wt %. Preferably, the first composition may contain non-aqueous carrier solvents in an amount of up to 85 wt %, preferably up to 80 wt %, more preferably up to 75 wt % or up to 70 wt %. Example solvents include glycols and other alcohols. Aqueous and non-aqueous mixtures may be employed.

### Sequestrants

Especially in the case where the bleach is in liquid form, it may contain sequestrant in order to stabilise a bleach component.

Example sequestrants include HEDP (1-Hydroxyethylidene-1,1-diphosphonic acid), for example sold as Dequest 2010, and (Diethylenetriamine penta(methylene phosphonic acid or Heptasodium DTPMP), Dequest® 2066. Conveniently the compositions may contain up to 2 wt % sequestrant.

A particularly preferred bleach composition may comprise a suspension of 6-(phthalimido) peroxyhexanoic acid (PAP) in water with sequestrant. PAP is commercially available in various liquid forms as Eureco LX5 (stabilized water suspension with 5% PAP crystals), Eureco LX10 and LX17 (stabilized water suspensions with 10 and 17% PAP crystals, respectively.

Excellent PAP stability is achieved at pH 3.7+/−0.2.

### Fluorescent Agents

It may be advantageous to include fluorescer in a composition and especially in the bleach composition. Usually, these fluorescent agents are supplied and used in the form of their alkali metal salts. The total amount of the fluorescent agent or agents used in the composition is generally from 0.005 to 5 wt %, preferably from 0.005 to 2 wt %, more preferably 0.01 to 0.5 wt %.

Preferred classes of fluorescer are: Di-styryl biphenyl compounds, e.g. Tinopal (Trade Mark) CBS-X and Tinopal CBS-CL, Di-amine stilbene di-sulphonic acid compounds, e.g. Tinopal DMS pure Xtra, Tinopal SBMGX, and Blankophor (Trade Mark) HRH, and Pyrazoline compounds, e.g. Blankophor SN.

Preferred fluorescers are: salts of: 2(4-styryl-3-sulfophenyl)-2H-napthol[1,2-d]triazole; 4,4′-bis{[(4-anilino-6-(N methyl-N-2 hydroxyethyl) amino 1,3,5-triazin-2-yl)]amino}stilbene-2-2′disulfonate; 4,4′-bis{[(4-anilino-6-morpholino-1,3,5-triazin-2-yl)]amino}stilbene-2-2′disulfonate; and 4,4′-bis(2-sulfostyryl)biphenyl.

### Shading Dyes

Shading dye can be used to improve the performance of the detergent compositions and may optionally be included in bleach or detergent compositions. Preferred dyes are violet or blue. It is believed that the deposition on fabrics of a low level of a dye of these shades, masks yellowing of fabrics. A further advantage of shading dyes is that they can be used to mask any yellow tint in the composition itself.

Suitable and preferred classes of dyes are discussed below.

### Direct Dyes:

Direct dyes (otherwise known as substantive dyes) are the class of water soluble dyes which have an affinity for fibres and are taken up directly. Direct violet and direct blue dyes are preferred.

Preferably bis-azo or tris-azo dyes are used.

Most preferably, the direct dye is a direct violet of the following structures:

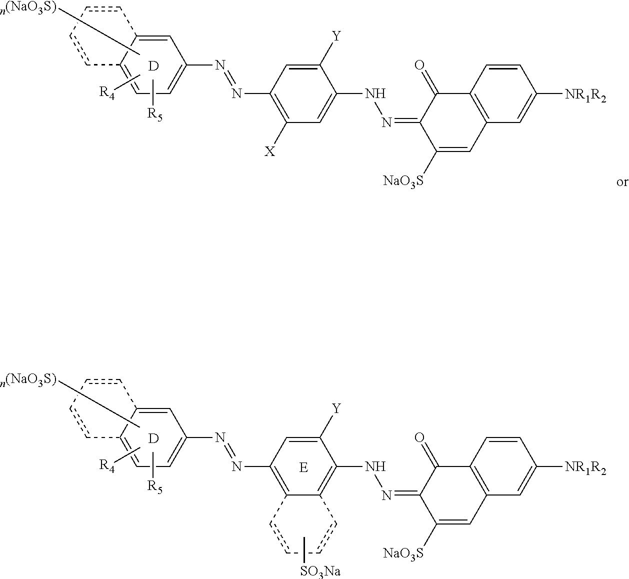

wherein:
ring D and E may be independently naphthyl or phenyl as shown;
R₁ is selected from: hydrogen and C₁-C₄-alkyl, preferably hydrogen; R₂ is selected from: hydrogen, C₁-C₄-alkyl, substituted or unsubstituted phenyl and substituted or unsubstituted naphthyl, preferably phenyl;
R₄ and R₅ are independently selected from: hydrogen and C₁-C₄-alkyl, preferably hydrogen or methyl;
X and Y are independently selected from: hydrogen, C₁-C₄-alkyl and C₁-C₄-alkoxy; preferably the dye has X=methyl; and, Y=methoxy and n is 0, 1 or 2, preferably 1 or 2.

Preferred dyes are direct violet 7, direct violet 9, direct violet 11, direct violet 26, direct violet 31, direct violet 35, direct violet 40, direct violet 41, direct violet 51, and direct violet 99. Bis-azo copper containing dyes for example direct violet 66 may be used. The benzidene based dyes are less preferred.

Preferably the direct dye is present at 0.000001 to 1 wt % more preferably 0.00001 wt % to 0.0010 wt % of the composition.

In another embodiment the direct dye may be covalently linked to the photo-bleach, for example as described in WO2006/024612.

### Acid Dyes:

Cotton substantive acid dyes give benefits to cotton containing garments. Preferred dyes and mixes of dyes are blue or violet. Preferred acid dyes are:
(i) azine dyes, wherein the dye is of the following core structure:

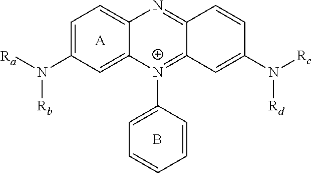

wherein Rₐ, R_{b}, R_{c} and R_{d} are selected from: H, a branched or linear C1 to C7-alkyl chain, benzyl a phenyl, and a naphthyl;
the dye is substituted with at least one SO₃⁻ or —COO⁻ group;
the B ring does not carry a negatively charged group or salt thereof; and
the A ring may further substituted to form a naphthyl; the dye is optionally substituted by groups selected from: amine, methyl, ethyl, hydroxyl, methoxy, ethoxy, phenoxy, Cl, Br, I, F, and NO₂.

Preferred azine dyes are: acid blue 98, acid violet 50, and acid blue 59, more preferably acid violet 50 and acid blue 98.

Other preferred non-azine acid dyes are acid violet 17, acid black 1 and acid blue 29.

Preferably the acid dye is present at 0.0005 wt % to 0.01 wt % of the formulation.

### Hydrophobic Dyes:

The bleach composition may comprise one or more hydrophobic dyes selected from benzodifuranes, methine, triphenylmethanes, napthalimides, pyrazole, napthoquinone, anthraquinone and mono-azo or di-azo dye chromophores. Hydrophobic dyes are dyes which do not contain any charged water solubilising group. Hydrophobic dyes may be selected from the groups of disperse and solvent dyes. Blue and violet anthraquinone and mono-azo dye are preferred.

Preferred dyes include solvent violet 13, disperse violet 27 disperse violet 26, disperse violet 28, disperse violet 63 and disperse violet 77.

Preferably the hydrophobic dye is present at 0.0001 wt % to 0.005 wt % of the formulation.

### Basic Dyes:

Basic dyes are organic dyes which carry a net positive charge. They deposit onto cotton. They are of particular utility for used in composition that contain predominantly cationic surfactants. Dyes may be selected from the basic violet and basic blue dyes listed in the Colour Index International.

Preferred examples include triarylmethane basic dyes, methane basic dye, anthraquinone basic dyes, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141.

### Reactive Dyes:

Reactive dyes are dyes which contain an organic group capable of reacting with cellulose and linking the dye to cellulose with a covalent bond. They deposit onto cotton.

Preferably the reactive group is hydrolysed or reactive group of the dyes has been reacted with an organic species for example a polymer, so as to the link the dye to this species. Dyes may be selected from the reactive violet and reactive blue dyes listed in the Colour Index International.

Preferred examples include reactive blue 19, reactive blue 163, reactive blue 182 and reactive blue, reactive blue 96.

### Dye Conjugates:

Dye conjugates are formed by binding direct, acid or basic dyes to polymers or particles via physical forces. Dependent on the choice of polymer or particle they deposit on cotton or synthetics. A description is given in WO2006/055787.

Particularly preferred dyes are: direct violet 7, direct violet 9, direct violet 11, direct violet 26, direct violet 31, direct violet 35, direct violet 40, direct violet 41, direct violet 51, direct violet 99, acid blue 98, acid violet 50, acid blue 59, acid violet 17, acid black 1, acid blue 29, solvent violet 13, disperse violet 27 disperse violet 26, disperse violet 28, disperse violet 63, disperse violet 77 and mixtures thereof.

Shading dye can be used in the absence of fluorescer, but it is especially preferred to use a shading dye in combination with a fluorescer, for example in order to reduce yellowing due to chemical changes in adsorbed fluorescer.

Particularly preferred embodiments of the first composition comprise bleach component in combination with at least one of (ia) fluorescer and/or (ib) shading dye.

### pH Adjustment Reservoir Composition

A further reservoir may preferably function as a pH switch to enhance performance of the bleach component during the wash cycle.

### pH Adjustment Agents

Example pH adjustment may be effected with an alkanolamine, such as monoethanolamine MEA, diethanolamine and triethanolamine TEA; alkali metal hydroxides, such as NaOH and KOH; alkali metal carbonates and bicarbonates such as sodium carbonate/bicarbonate and alkali metal silicates such as sodium silicate. Mixtures of bases may be employed.

Preferably the composition for providing a pH switch has an in-reservoir pH of at least 8, preferably at least 9, more preferably at least 10, especially at least 11, most preferably at least 12 and optionally at least 13. The concentration of base is selected in order to provide an in wash pH of 8 to 11, preferably 8 to 10, optionally 8 to 9.5, particularly 8 to 9.

### Builders and Sequestrants

The pH adjustment composition also preferably includes builder and/or sequestrant. Examples include the alkali metal carbonates, citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids, and citric acid. Other examples are DEQUEST™, organic phosphonate type sequestering agents sold by Monsanto and alkanehydroxy phosphonates. Salts of carbonic acid and citric acid are preferred, especially sodium carbonate and sodium citrate.

Other suitable organic builders include the higher molecular weight polymers and copolymers known to have builder properties. For example, such materials include appropriate polyacrylic acid, polymaleic acid, and polyacrylic/polymaleic acid copolymers and their salts, for example those sold by BASF under the name SOKALAN™.

An appropriate amount of builder will depend upon the product form of the composition in particular whether it is a powder or a liquid. In preferred embodiments of the invention the second composition is in liquid form. Preferably the second composition contains from 5 to 40 wt % of builder component, especially up to 30 wt %, more preferably up to 25 wt % and most preferably up to 20 wt %.

Example sequestrants are HEDP (1-Hydroxyethylidene-1,1-diphosphonic acid), for example sold as Dequest 2010, and (Diethylenetriamine penta(methylene phosphonic acid or Heptasodium DTPMP), Dequest® 2066. Preferably the compositions contain up to 5 wt % sequestrant, especially from 0.1 wt % to 3 wt %.

The pH adjustment composition may additionally contain detergent components such as surfactants which are stable at the in-reservoir pH of the composition. In addition, or alternatively detergent may be provided in a third composition.

### Compositions Comprising at Least One Enzyme

The device may comprise one or more enzyme compositions. While enzymes are powerful stain removers, for many wash loads some or all enzymes may be omitted. For example, different families of enzymes are effective against different classes of stain, and a large number of laundry loads are not stained at all. Including enzymes in each and every wash may therefore be wasteful.

The inventors have observed that certain enzymes cannot be stored in combination. For example, protease and lipase cannot usually be combined in a single liquid composition because as the protease may digest the lipase on storage. Similarly, protease may digest cellulase on storage in a liquid. However, lipase gives excellent benefits on removal of fats, while cellulase gives improved fabric treatment with colour preservation and pill removal and/or background whiteness benefit (depending on the cellulase used). This means that conventional laundry projects often contain an enzyme mix.

The present invention permits, through use of more than one reservoir comprising an enzyme composition, the assorted benefits of these enzymes to be accessed in a single load.

For example, the device may comprise a reservoir (ii) containing a first composition comprising a protease and a further reservoir (iii) containing a second composition comprising a cellulase and/or a lipase. Neither, one or both of these compositions may then be supplied depending on, for example, the type of staining.

In some embodiments, the composition of reservoir (ii) comprises a protease. Suitably, the composition of reservoir (ii) does not contain a cellulase and/or a lipase. The composition of reservoir (ii) may optionally further comprise a pectate lyase.

The composition of reservoir (ii) may optionally further comprise a surfactant, for example, sodium laureth sulfate (SLES). This additional surfactant may be used to boost detergency over and about that of the detergent composition, which may be useful in the case of stained loads. Certain surfactants are also known to be more suited to enzymatic cleaning processes.

The device may dispense the composition of reservoir (ii) for stains such as grass and blood.

In some embodiments, the composition of reservoir (iii) comprises a cellulase and/or a lipase and/or an amylase. Preferably, the composition of reservoir (iii) comprises a lipase. Suitably, the composition of reservoir (iii) does not contain a protease.

In some cases, the composition of reservoir (iii) comprises a cellulase.

In some cases, the composition of reservoir (iii) comprises a lipase.

In some cases, the composition of reservoir (iii) comprises an amylase.

Naturally, the composition of reservoir (iii) may comprise any combination of these enzymes.

The composition of reservoir (iii) may optionally further comprise a mannanase. The composition of reservoir (iii) may optionally further comprise a surfactant for example SLES. As described for (ii), this additional surfactant may be used to boost detergency over and about that of the detergent composition, which may be useful in the case of stained loads.

The device may dispense the composition of reservoir (iii) for stains such as gravy, starch-based stains, chocolate and chocolate products, fatty cooking stains.

### Additional Ingredients Up to 100%

The compositions may contain additional ingredients such a fragrance, colorants, pearlisers and/or opacifiers. Typically such additional ingredients will be present in a total amount of less than 10 wt %, more preferably less than 9 wt % and especially less than 8 wt %. Additionally or alternatively, such additional ingredients may be provided in one or more additional reservoirs.

### External Structurants

The compositions may have their rheology further modified by use of a material or materials that form a structuring network within the composition. Suitable structurants include hydrogenated castor oil, microfibrous cellulose and natural based structurants for example citrus pulp fibre. Citrus pulp fibre is particularly preferred especially if lipase enzyme is included in the composition. Preferably, if utilised, such external structurants are present in an amount of less than 2 wt %, preferably less than 1 wt %.

### Visual Cues

The compositions may comprise visual cues of solid material that is not dissolved in the composition. Preferred visual cues are lamellar cues formed from polymer film and possibly comprising functional ingredients that may not be as stable if exposed to the alkaline liquid. Enzymes and bleach catalysts are examples of such ingredients. Also perfume, particularly microencapsulated perfume.

### Packages and Dosing

The compositions are preferably in liquid form. Each composition is preferably provided in a reservoir cartridge adapted for use with a dosing device which is operable to selectively dispense portions of a composition from a reservoir into a dosing unit upon command by a user, such as in a manner as described herein.

A reservoir cartridge may contain a stock of a composition in an amount sufficient for two or more doses, preferably for three or more and more preferably for five or more doses of laundry product. A cartridge may be disposable or be designed to be refillable.

A combination of cartridges can provide segregated stocks of components in amounts sufficient to provide multiple doses of laundry products. Directions may be provided to guide the user to make certain selections in dependence upon factors such as fabric type and nature of staining. A dosing unit (such as a ball) may also be provided as part of a kit for formulating multiple doses of laundry products.

### Apparatus

A further aspect of the invention concerns an apparatus for providing laundry product, the apparatus comprising a dosing unit and a dispensing device having reservoirs for containing laundry product components, wherein the device is operable to selectively dispense portions of components from the reservoirs so as to provide a dose of laundry product in the dosing unit as a result of input by a user, wherein the apparatus has a reservoir containing a stock of a composition containing a detergent component and a reservoir containing a stock of a composition containing a component which may be capable of initiating and/or promoting action of the bleach component and preferably contains a source of alkalinity. Preferably, the device has a computer programmed to cause the device to selectively dispense components from the reservoirs as a result of input by the user.

The apparatus may be configured such that the dosing unit and dispensing device are located externally of the washing machine and the dosing unit is adapted to be manually placed in the washing machine, especially in the washing machine drum. The dose of laundry product may also be supplied to the drum via a drawer.

In other embodiments an apparatus may be associated with the washing machine such that a dispensing device is located in a washing machine and is operable to dispense portions of components from reservoirs into a washing machine drum as a result of input by a user. Components may be dispensed directly into the water flow to form a wash liquor or into a chamber or pipe through which water subsequently flows.

Additional reservoirs may be provided containing further laundry product components, in particular active ingredients for laundry detergent. The respective reservoirs are generally separate and segregated from one another. Preferably the apparatus includes at least a third reservoir containing a stock of detergent composition.

Method aspects of the invention concern combining compositions from the reservoirs of the first and second aspects to provide laundry products, and preferably to provide liquid laundry detergent compositions. A preferred method concerns activating an apparatus such as according to the third aspect, to combine portions of stock compositions from the reservoirs so as to provide a dose of a laundry product in a dosing unit, and subsequently supplying the laundry product to the drum of a washing machine.

Embodiments of the invention may also provide a kit for a user to formulate bespoke doses of laundry product, wherein the kit includes a combination of reservoirs providing segregated stocks of laundry product components as described herein, optionally together with directions for combining selected portions of stock components in order to provide various alternative options for a dose of laundry product. A kit may optionally include a dosing unit for accommodating a dose of laundry product to be supplied to a washing machine, suitably by placing a dosing unit in a washing machine drum.

In the various aspects of the invention, the dosing unit may be conventional dosing ball, or may have one or more features designed to complement or otherwise interact with the dosing device.

For an apparatus aspect of the invention, laundry product may be dispensed by a computer module according to input provided before the wash or rinse cycle begins (in other words before a wash/rinse liquor is formed, as appropriate). Input may be provided in various ways, for example by the user making choices or providing suggestions, or through sensing a tag or label on the article to be laundered such as a QR “quick response code”. Suitably, this input is captured via a user interface on the device. The device may include a graphical user interface (GUI). For example, the GUI may be presented to the user on a digital screen of the user interface. Input from the user may be captured by the user interface of the device via various user interaction mechanisms including: manipulation of buttons, touch screen, voice commands, gestures or other suitable methods. The computer module may communicate with an external user device such as a mobile phone, tablet or laptop to receive user inputs from a user interface on the external device. Using the interface, the user may select a suitable laundry product recipe, or the computer module may select, generate or obtain a recipe based on input from the user (load type, staining, preferences etc). The recipe used to determine the amounts may be obtained from an internal memory within the device, or may be obtained from an external memory accessed, for example, via the internet.

The user interface may include a facility to input data in sets, for example through asking the user to select certain options or alternatives. Accordingly, the device may have or communicate with a user interface via which the user is able to input data using at least two sets of options.

At least one set of options may prompt the user to input stain identity (grass, chocolate, blood etc) and at least one set of options may prompt the user to input fabric colour and/or type. (e.g. cotton, polycotton, polyester).

Based on the data provided for each of these sets, an algorithm may be employed to determine the optimal formulation, balancing the cleaning needs of certain stains against others. The algorithm may be stored and accessed on the computer module of the device, or it may be obtained from an external source such as the internet.

Accordingly, in some cases the computer module is programmed with an algorithm to determine how much product is dosed from each reservoir based on the user input. Thus, in some cases the computer module is programmed to communicate with an external source to access an algorithm and determine how much product is dosed from each reservoir based on the user input.

Each reservoir may be in controllable fluid communication with a dispensing nozzle which dispenses into the dosing unit. The compositions from the various reservoirs may be dispensed directly into the dosing unit (as it is not necessary that the various compositions are mixed before use) or may be dispensed via a pre-mixing chamber, which mixes two or more compositions prior to dispensing.

The reservoirs may be integral to a housing of the device or, more preferably, they may be provided as pre-filled cartridges that cooperate with the housing of the device, such that the composition in the reservoir is in fluid communication with a nozzle for dispensing the composition into the dosing unit or a pre-mixing chamber.

According to preferred embodiments of the invention the reservoirs comprise individual discrete cartridges.

A reservoir cartridge may have stiff walls. In other words, the cartridge may be form-retaining so that it can retain its shape regardless of the amount of laundry product in the reservoir. A reservoir cartridge may have flexible walls. It will be appreciated that the cartridge may be configured to suit the overall design and shape of the apparatus. Said reservoir cartridge may be, without limitation, a pouch or stiff plastic container.

Each reservoir cartridge may be fixable to the apparatus such that the contents of the reservoir are sealable by a valve. Suitably, therefore, the cartridge comprises mating means configured to engage with complementary mating means on the apparatus such that, when in place, the reservoir cartridge is held securely and laundry product within the reservoir cartridge is contained or released according to whether the valve of the apparatus is in a closed or open state. In other words, the cartridge may comprise a connecting portion which mates with a complementary connection portion of the apparatus.

Additionally or alternatively, the contents of the reservoir may be supplied by pressure and/or vacuum generated within the apparatus. It will be appreciated that the device may have a pump to move liquids from the reservoirs to the dosing nozzle, optionally via a pre-mixing chamber, to be dispensed.

Accordingly, each reservoir cartridge may be fixable to the device by mating means configured to engage with complementary mating means on the device such that, when in place, the reservoir cartridge is held securely and laundry product within the reservoir cartridge is contained or released according to whether the pump is on or off.

### DETAILED DESCRIPTION

Particularly preferred embodiments of the invention will now be described, by way of examples.

### Apparatus

Embodiments of the apparatus aspect of the invention will now be described with reference to the following diagrammatical drawings in which:

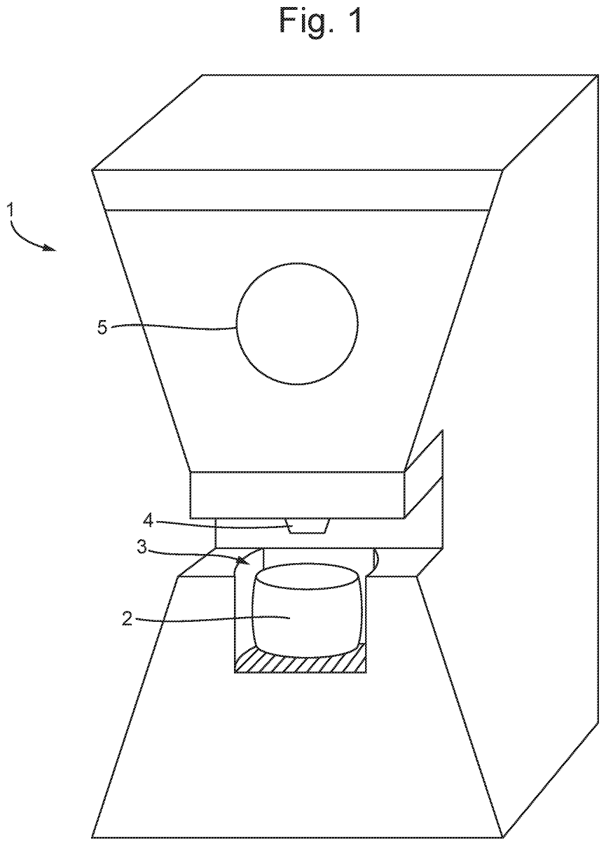

FIG. 1 shows a representative drawing of an apparatus according to an embodiment of the invention.

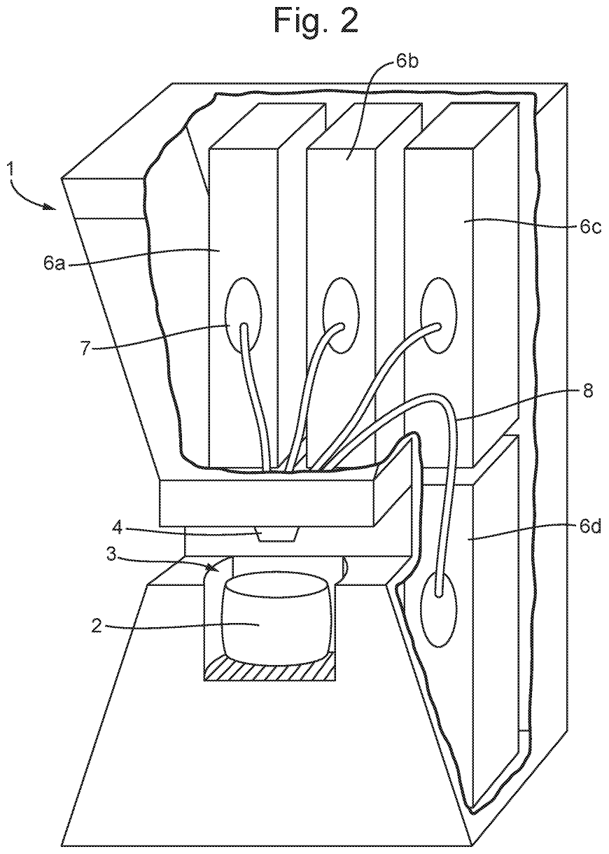

FIG. 2 shows a partially cut away representative drawing of the above apparatus showing part of the cartridge arrangement.

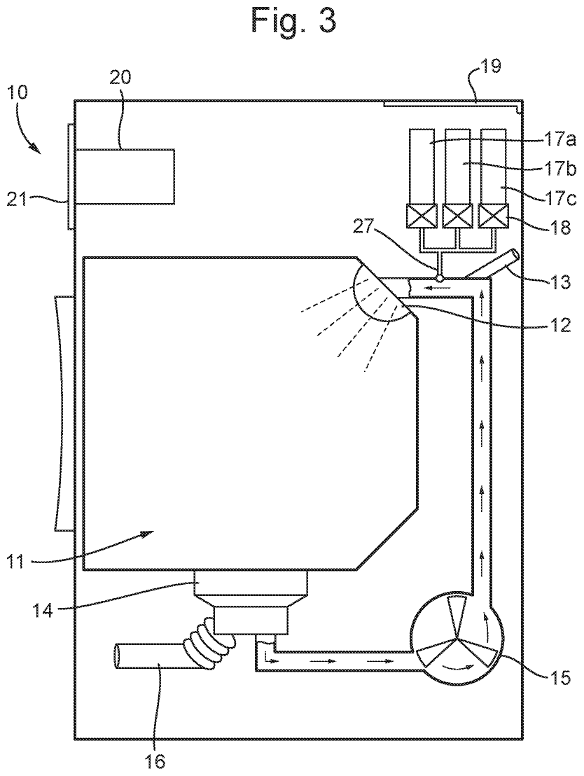

FIG. 3 shows a cross-section drawing of a device for formulating doses of the present compositions which is integral to a washing machine.

The apparatus as illustrated in FIG. 1 has a dispensing device 1 and a dosing unit 2. The apparatus is a standalone device, designed to be placed on a countertop or similar. For example, it may be placed on a countertop in a kitchen or utility room, or may be placed on top of a washing machine.

As illustrated, the dosing unit 2 is a conventional dosing ball, which is typically made of plastics material. In use, the dosing unit is placed in a dispensing area 3 located underneath a nozzle 4. As illustrated, the dispensing area 3 is a recess provided in the device housing, and the dosing unit 2 is placed on a surface provided in the housing. However, it will be appreciated that the housing may be shaped in different ways such that, for example, the dosing unit is placed directly on the countertop (or other surface on which the device is placed) in use.

Laundry product ingredients are dispensed into the dosing unit 2 via the nozzle 4. As shown, only one nozzle is used. However, it will be appreciated that more than one nozzle may be provided. For example, different reservoirs may be in fluid communication with different nozzles such that a first reservoir is in fluid communication with a first nozzle and a second reservoir is in fluid communication with a second nozzle.

The device has a control/information interface 5. As illustrated, the interface 5 is a touch screen provided in the housing that both displays information and allows selections and information to be inputted to a computer module (not shown).

However, in other embodiments the device may be provided with a panel having buttons, dials or similar for inputting information. In other embodiments, input may be conveyed via command or gesture. It will be appreciated that a display screen in the housing of the device is not essential. The device may be configured for use without a display screen, or an external display screen on for example a phone or tablet may be coupled to the device (for example, via Bluetooth or similar).

FIG. 2 shows a partially cutaway image of the apparatus of FIG. 1. In this embodiment the interior houses three reservoir cartridges 6a, 6b, and 6c. Each cartridge houses a stock of an ingredient composition.

For example, in this non-limiting illustrated embodiment, 6a houses a detergent base composition, 6b houses an anti-malodour composition, and 6c houses an enzyme composition. Each cartridge 6a, 6b, 6c has a valve 7 and each cartridge is in fluid communication with a nozzle via a flow path 8. Flow from a cartridge to the nozzle 4 (where it is dispensed) is controlled by the valve. In this embodiment therefore each valve is a metering valve, with the volume metered controlled by the computer module. The valves may be located at any point along the flow path, and other types of valve may be used. Also metering of the ingredient compositions may be achieved in other ways, for example through generation of pressure in the reservoir to force the liquid out.

The diagram shows individual flows running from each reservoir to the nozzle 4. It will be appreciated that flow paths may meet before the nozzle is reached. For example, the device may have a pre-mixing chamber in which different ingredient compositions meet before they are dispensed into the dosing unit.

In use, the dosing unit is located under the nozzle 4 (such that product dispensed through the nozzle enters a chamber of the doing device). The user inputs information about the laundry load to the computer module. Typically, data may be entered in in two or more sets, each set requiring certain information from the user. For example, Set I may be used to input the load type: whites or colours. Set II may be used to input the presence or absence of staining and, optionally, the stain type. The user may therefore select whites, grass stains, mud stains. Other data requirements may include the fabric type (cotton/polycotton/polyester) as optimal fabric care benefit agents and amounts may be different in each case; fragrance selection (different members of the household may prefer different fragrances for their clothing, or it may be desirable to fragrance bedding and towels but not clothes); extent of staining (for example, lots of grass stains, only light mud stains); size of load (small loads require less product).

An optimised wash composition is then determined and the appropriate amount from relevant cartridges dispensed. The computer module (not shown) controls the amount dispensed.

The recipe used to determine the amounts may be obtained from an internal memory within the device, or may be obtained from an external memory accessed, for example, via the internet. Often, particularly where there is more than one stain type, an algorithm may be employed to determine the optimised formulation, balancing the cleaning needs of certain stains against others.

For example, in the case where reservoir cartridge 6a houses a detergent base composition which has a high pH, it may be appropriate to dispense 6a and 6b alone to provide the laundry product. In the case where reservoir cartridge 6a houses a detergent base composition having a low pH, it may be appropriate to dispense from 6a, 6b and 6c, in order to provide a sufficient pH switch to activate the bleach component. If it is desired to provide a bleach component for cleaning or disinfecting the machine without the need for detergent surfactant, it may be appropriate to dispense from 6b and 6c alone.

It will be appreciated that various further reservoir cartridges may be provided, each containing one or more ingredients for a laundry product to enhance versatility of the system.

The user may select various options, such as type of stain and type of fabric, and the computer module may then dose appropriate amounts of components from the relevant reservoir cartridge in to the dosing ball ready to be introduced in to the washing machine drum by the user.

The illustrated embodiment concerns a standalone apparatus in which the dispensing device and the dosing unit are located externally of the washing machine.

In other embodiments a dispensing device and/or a dosing unit may be accommodated within a washing machine. The dosing unit may be arranged in fluid communication with the washing machine drum so that the dose of laundry product is supplied without the need for the user to handle it.

FIG. 3 illustrates a device which is integral to a washing machine 10. The washing machine has a drum area 11 in which articles are laundered. During a wash program, water and wash liquor enter the drum via a sprayer 12. Water enters the machine via inlet 13 (schematically and only partially shown). Water and wash liquor drain from the drum area 11 into a sump 14 and may then recirculate via recirculating pump 15 (arrows indicate direction) to be resprayed into the drum area, or may be drained via waste outlet 16. Reservoirs 6a, 6b, and 6c contain stocks of components, as before. As shown, these are cartridges that engage with dispensing means 18, although it will be appreciated that the reservoirs may be provided simply as containers into which compositions are poured. The cartridges may be loaded and changed through access flap 19.

The device has a computer module 20. As described herein the computer module controls which and optionally how much of each cartridge is dispensed. As shown here, the washing machine has a control panel 21 via which input may be provided to the computer module. As illustrated, the control panel is a touch screen. In the present case, the control panel and computer module are also the used to determine the machine program, although it will be appreciated that they may be separate.

As previously described, in use the user inputs information about the laundry load to the computer module 20. The optimal wash composition is then determined and the appropriate amount from relevant cartridges dispensed by dispensing means 18 and may be combined before entering the water flow of the machine for example in a single pipe or chamber. This may be termed a pre-mixing area 27. As illustrated, three individual pipes combine to a single pipe, via which the product is dosed. In other words, the ingredient compositions dispensed may be at least partially premixed before being diluted to provide a wash liquor. The computer module controls the amount dispensed.

1. A combination of reservoirs providing segregated stocks of components for laundry products to enable a user to formulate doses of laundry products on demand for supplying to a washing machine drum, the combination comprising:
a first reservoir containing a stock of a first composition containing a detergent; and
a second reservoir containing a second composition comprising a stock of an anti-malodour component, said anti-malodour component excluding detergent, bleach and perfume.

2. The combination according to claim 1 wherein the anti-malodour component comprises a cyclodextrin.

3. The combination according to claim 1 wherein the anti-malodour component comprises a component selected from the group: odour-blockers, reactive aldehydes, flavonoids, metallic salts, zeolites, activated carbon; and/or mixtures thereof.

4. The combination according to claim 1 wherein the anti-malodour component comprises zinc ricinoleate.

5. The combination according to claim 1 wherein the anti-malodour component comprises zinc ricinoleate and a substituted monocyclic organic compound whereby the substituted monocyclic organic compound is in the alternative or in combination with one or more of:
1-cyclohexylethan-1-yl butyrate;
1-cyclohexylethan-1-yl acetate;
1-cyclohexylethan-1-ol;
1-(4′-methylethyl) cyclohexylethan-1-yl propionate; and
2′-hydroxy-1′-ethyl(2-phenoxy)acetate.

6. The combination according to claim 1 wherein the anti-malodour component comprises a deposition aid.

7. The combination according to claim 1 wherein the deposition aid comprises a polymeric deposition aid.

8. The combination according to claim 1 wherein the deposition aid comprises a polysaccharide.

9. The combination according to claim 1 including at least one further reservoir containing at least one further composition comprising at least one stock of an enzyme component.

10. The combination according to claim 1 including at least one further reservoir containing a perfume.

11. A device (1) for supplying a dose of laundry product, the device having multiple reservoirs including:
(i) a reservoir (6a) containing a first composition comprising a detergent;
(ii) a reservoir (6a) containing a composition comprising an anti-malodour component, and one or more reservoirs selected from:
(iii) a reservoir (6b) containing a composition comprising a first enzyme;
(iv) a reservoir (6c) containing a composition comprising a second enzyme, wherein the second enzyme is different to the first enzyme;
(v) a reservoir (6d) containing a composition comprising a bleach component; and
(vi) a reservoir (6e) containing a composition comprising an alkaline component wherein the device has a computer module programmed to cause the device to dispense from one or more reservoirs to provide a laundry product in the dosing device as a result of input.

12. The combination of reservoirs according to claim 1 wherein the first composition and-/-or second composition are in liquid form.
